(19) United States
(12) Patent Application Publication
(10) Pub. No.: US 2011/0013319 A1
(43) Pub. Date: Jan. 20, 2011

(54) DISK DRIVE WITH MICRO-ACTUATOR INTERCONNECT CONDITIONING

(76) Inventors: Eiji Soga, Kanagawa (JP); Hiroyasu Tsuchida, Kanagawa (JP); Akio Takatsuka, Kanagawa (JP); Masaru Muranishi, Kanagawa (JP); Hidehiko Numasato, Kanagawa (JP)

Correspondence Address: HITACHI C/O WAGNER BLECHER LLP, 123 WESTRIDGE DRIVE, WATSONVILLE, CA, 95076, US

(21) Appl. No.: 12/839,342

(22) Filed: Jul. 19, 2010

(30) Foreign Application Priority Data
Jul. 19, 2009 (JP) 2009-168310

(51) Int. Cl. G11B 5/48

(52) U.S. Cl. 360/246.1; G9B/5.147

(57) ABSTRACT

A disk drive configured with micro-actuator interconnect conditioning. The disk drive includes a disk, a head, an actuator, a piezoelectric element, a hardened conductive adhesive, a voltage-supply circuit, and a controller. The head is configured to access the disk. The actuator includes a suspension supporting the head, and an arm supporting the suspension. The piezoelectric element is disposed on the suspension, is electrically connected to a first drive line and a second drive line, and is configured to change the position of the head. The hardened conductive adhesive is electrically connected to at least one connecting part of the piezoelectric element and the first drive line. The voltage-supply circuit is configured to supply a voltage to the piezoelectric element. The controller is configured to control a voltage-control circuit each time a designated process is executed, and to apply a voltage to the piezoelectric element with a prescribed maximum absolute value.

### CROSS-REFERENCE TO RELATED APPLICATION

This application claims priority from the Japanese Patent Application No. 2009-168310, filed Jul. 19, 2009, the disclosure of which is incorporated herein in its entirety by reference.

### TECHNICAL FIELD

Embodiments of the present invention relate to a disk drive, and relates in particular to a method of applying voltage to a piezoelectric element in a disk drive having an actuator that is micro-driven by a piezoelectric element.

### BACKGROUND

Devices that use disks with a variety of formats such as optical disks, magneto-optical disks, and flexible magnetic-recording disks are known in the art; but, of these, the hard-disk drive (HDD) is widely used as a computer storage device, and has now become an indispensable storage device for computer systems. In addition, applications for the HDD such as video recording and playback devices, satellite navigation systems and mobile phones are rapidly increasing due to its extraordinary versatility.

Magnetic-recording disks used in an HDD are provided with a plurality of data tracks and a plurality of servo tracks formed concentrically. Each data track includes a plurality of data sectors that contain user data. The servo tracks have data addresses. The servo tracks include a plurality of servo sectors that are divided around the circumference of the magnetic-recording disk, and between each portion with servo data is recorded one or a plurality of data sectors. A magnetic-recording head is provided to write data to, or read back data from, data sectors by accessing a desired data sector following the address data for the servo data. As used herein, “access” is a term of art that refers to operations in seeking a data track of a magnetic-recording disk and positioning a magnetic-recording head on the data track for both reading data from, and writing data to, the magnetic-recording disk.

The magnetic-recording head is formed on a slider, and this slider is furthermore affixed to the suspension of an actuator. The actuator and head-slider assembly is known as a head-stack assembly (HSA). Moreover, the suspension and head-slider assembly is known as a head-gimbal assembly (HGA). The head-slider is able to fly in proximity with a recording surface of the magnetic-recording disk due to the balance between pressure due to the viscosity of the air between the rotating magnetic-recording disk and the air-bearing surface (ABS) of the slider facing the magnetic-recording disk, and a load applied by the suspension in the direction of the magnetic-recording disk. The actuator, referred to by the term of art “rotary actuator,” rotates to and fro about a pivot axis, moves the head-slider to a desired track, and also determines position of the head-slider on this track.

With increases in the areal recording density of magnetic-recording disks, there is a need to improve positioning accuracy for the head-slider across the width of the track. However, there is a limit to the accuracy of positioning that can be delivered by an actuator driven by a voice coil motor (VCM). For this reason, a dual-stage actuator technology that allows more accurate positioning has been proposed in which a compact actuator, referred to by the term of art “micro-actuator,” is disposed on the rotary actuator.

One form of micro-actuator is a structure in which the head-slider is micro-driven by a piezoelectric element affixed to the suspension. This kind of micro-actuator includes one or two piezoelectric elements affixed on a gimbal tongue, load boom, or base plate. The micro-actuator is able to position the head-slider directly, or with partial rotation of the suspension, with a high degree of accuracy in the radial direction of the head-slider through the expansion of the piezoelectric element. Engineers and scientists engaged in HDD manufacturing and development are interested in advancing the performance of actuators employing such piezoelectric elements.

### SUMMARY

Embodiments of the present invention include a disk drive configured with micro-actuator interconnect conditioning. The disk drive includes a disk, a head, an actuator, a piezoelectric element, a hardened conductive adhesive, a voltage-supply circuit, and a controller. The head is configured to access the disk. The actuator includes a suspension that supports the head, and an arm that supports the suspension. The piezoelectric element is disposed on the suspension, and is electrically connected to a first drive line and a second drive line; the piezoelectric element is also configured to change the position of the head by expanding and contracting. The hardened conductive adhesive is electrically connected to at least one connecting part of the piezoelectric element and the first drive line. The voltage-supply circuit is configured to supply a voltage to the piezoelectric element. The controller is configured to control a voltage-control circuit each time a designated process is executed, and to apply a voltage to the piezoelectric element across the first drive line and the second drive line with a prescribed maximum absolute value.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a plan view showing the chassis of the hard-disk drive (HDD) without a cover, in accordance with an embodiment of the present invention.

FIG. 2 is a plan view schematically illustrating the structure of a head-gimbal assembly (HGA), in accordance with an embodiment of the present invention.

FIG. 3 is a diagram illustrating a schematic oblique view of the structure of the piezoelectric element and the vicinity of the piezoelectric element in the HGA, in accordance with an embodiment of the present invention.

FIG. 4 is a cross-section and plan view schematically illustrating the structure of the piezoelectric element, the stiffener surface of the piezoelectric element, the interconnecting parts of the stiffener and the piezoelectric element and the vicinity of the stiffener and the piezoelectric element in the HGA, in accordance with an embodiment of the present invention.

FIG. 5 is a block diagram schematically illustrating the overall structure of the control system in the HDD, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### DESCRIPTION OF EMBODIMENTS OF THE PRESENT INVENTION FOR A DISK DRIVE CONFIGURED WITH MICRO-ACTUATOR INTERCONNECT CONDITIONING

With relevance for embodiments of the present invention, for a micro-actuator that uses a piezoelectric element, deterioration in the piezoelectric element may occur, as is known in the art. If a piezoelectric element has a small fault internally, repeated expansion and contraction will accelerate deterioration in capacitance and electrical resistance due to this fault. Means of resolving the occurrence of deterioration in the characteristics of the piezoelectric element caused by an internal fault is known in the art.

Specifically, as is known in the art, a hard-disk drive (HDD) may be provided with a fault detection unit that detects deterioration in performance due to a fault in the piezoelectric element, and a performance-restoring unit that restores the characteristics by applying a high AC voltage to the piezoelectric element when a fault is detected. The fault detection unit detects deterioration by measuring the resistance when a specified voltage is applied to the piezoelectric element. Moreover, the performance restoration unit applies a high AC voltage to the piezoelectric element when deterioration is detected, burning out an electrical short within the piezoelectric element. By this means the performance of the piezoelectric element may be restored.

With further relevance for embodiments of the present invention, technology known in the art has the purpose of restoring the performance of a piezoelectric element from deterioration caused by an internal fault in the piezoelectric element. To remove a fault in the piezoelectric element caused by a failure of the insulation, an extremely high voltage may be applied to the piezoelectric element. However, such high voltage places extreme stress on the piezoelectric element. For this reason, the above technology makes the detection of deterioration in a piezoelectric element a condition for the deterioration restoration process. Moreover, the technology uses AC voltage to reduce the stress applied to the piezoelectric element by the high voltage.

Deterioration in the performance of a micro-actuator that uses a piezoelectric element can be due to factors other than deterioration in the performance of the piezoelectric element. One of the main reasons is deterioration in the electrical connections of the piezoelectric element. A piezoelectric element has terminals that receive the signal voltage for expansion and contraction. The terminals of the piezoelectric element are connected electrically and physically to the suspension body or to wiring terminals on the suspension. Various ways are known for making electrical and physical connections between the piezoelectric element terminal and wiring terminals or the suspension body; but, of these, a method known for manufacturing efficiency is a connection using a conductive adhesive.

A conductive adhesive has conductive particles in a resin material; the resin material permits a physical connection; and, the conductive particles enable an electrical connection. When using conductive adhesive to connect the piezoelectric element to the suspension body, deterioration can be observed in these interconnecting parts, when the HDD is out of use for a long time. As used herein, the interconnecting parts to the piezoelectric element are also referred to as micro-actuator interconnects. Specifically, the resistance of the interconnecting parts increases; and, the drive of the piezoelectric element becomes difficult to control accurately with the control voltage. This deterioration is particularly likely to occur where the piezoelectric element is connected to a stainless steel suspension body using silver particle conductive paste, which is one kind of conductive adhesive. Furthermore, the above-described deterioration is more widely observed when there exists a surface with a high proclivity for affecting conductivity through an oxidized film, or similar film having reduced conductivity.

To control deterioration in performance and to reliably prevent erasure of user data, constant and accurate control of the micro-actuator is utilized. As described above, one approach known in the art is to apply a high voltage to burn out the electrically shorted portion within the piezoelectric element. To lessen the stress applied to the piezoelectric element by the high voltage, this procedure to restore performance is performed on the condition that deterioration in performance of the piezoelectric element itself is detected. As a result, accurate control of the micro-actuator may prove to be difficult over the period from when the deterioration in performance of the piezoelectric element begins to the time when it is detected.

The characteristics of deterioration in interconnecting parts made of conductive paste are different from those of deterioration in the performance of the piezoelectric element itself. For this reason, the occurrence of high resistance in the interconnecting parts of the piezoelectric element is to be prevented by means of a process able to cope with deterioration in the interconnecting parts, which is different from deterioration in performance caused by a fault in the piezoelectric element. By this means, deterioration in performance and the occurrence of hard errors caused by high resistance in the interconnecting parts of the piezoelectric element might be prevented.

In accordance with embodiments of the present invention, a disk drive configured with micro-actuator interconnect conditioning includes a disk, a head, an actuator, a piezoelectric element, a hardened conductive adhesive, a voltage-supply circuit, and a controller. The head is configured to access the disk. The actuator includes a suspension that supports the head, and an arm that supports the suspension. The piezoelectric element is disposed on the suspension, and is electrically connected to a first drive line and a second drive line; the piezoelectric element is also configured to change the position of the head by expanding and contracting. As used herein, a micro-actuator includes a piezoelectric element; and, micro-actuator interconnects may be referred to as interconnecting parts to the piezoelectric element. The hardened conductive adhesive is electrically connected to at least one connecting part of the piezoelectric element and the first drive line. The voltage-supply circuit is configured to supply a voltage to the piezoelectric element. The controller is configured to control a voltage-control circuit each time a designated process is executed, and to apply a voltage to the piezoelectric element across the first drive line and the second drive line with a prescribed maximum absolute value. Thus, by applying voltage in this way, which is referred to herein as “conditioning,” in accordance with embodiments of the present invention, deterioration may be prevented in the accuracy of positioning control caused by deterioration in the interconnecting parts between the piezoelectric element and the drive line due to the conductive adhesive.

In accordance with embodiments of the present invention, the conductive adhesive includes an interconnecting part between the surface of the body of the suspension and the connecting part; the suspension includes the first drive line; and, said controller is configured to apply a standard voltage to a connecting terminal. Deterioration is liable to occur in the conducting adhesive, which interconnects the surface of the body of the suspension and the connecting parts; and, embodiments of the present invention effectively prevent deterioration in the accuracy with which positioning is controlled. Furthermore, from the same perspective, in one embodiment of the present invention, the surface of the body may include an oxidized metal film. Moreover, in another embodiment of the present invention, the suspension includes a stainless steel structure; and, the oxidized metal film includes a passivation film.

In other embodiments of the present invention, the designated process may be selected from said group of processes consisting of: an initial setup process for the disk drive; a loading process that moves the suspension over the disk from a waiting position; an unloading process that moves the suspension from over the disk to the waiting position; an error recovery process; and, an idling process that interrupts access of the head to the disk. Thus, in accordance with embodiments of the present invention, by applying the above voltage each time one of these processes is executed, the state of the interconnecting parts due to the conductive adhesive may be effectively restored, while reducing the effect on device performance.

In another embodiment of the present invention, before moving the head over the disk from the waiting position in the initial setup process, the controller is configured to apply a voltage to the piezoelectric element with the prescribed maximum absolute value. Thus, in an embodiment of the present invention, by this means, the state of the interconnecting parts may be reliably and safely restored before the device begins operating.

In another embodiment of the present invention, the controller is configured to apply a DC voltage having the prescribed maximum absolute value to the piezoelectric element. Thus, in an embodiment of the present invention, by this means, the state of the interconnecting parts may be effectively restored.

In another embodiment of the present invention, the voltage-supply circuit includes a driver circuit that is configured to drive the piezoelectric element during access by the head; and, the maximum absolute value includes a value within the range of voltage that can be applied to the piezoelectric element by the driver circuit during access of the head to the disk. Thus, in an embodiment of the present invention, by this means, damage to the piezoelectric element may be avoided; and, the structure of the circuit may be kept simple. Furthermore, in another embodiment of the present invention, the maximum absolute value matches the maximum absolute value of voltages that can be applied to the piezoelectric element by the driver circuit during access to the disk by the head. Thus, in an embodiment of the present invention, by this means, the state of the interconnecting parts may be effectively restored.

In another embodiment of the present invention, the piezoelectric element includes two portions having different directions of polarization; the controller is configured to simultaneously apply voltage with the prescribed maximum absolute value to these two portions. Thus, in an embodiment of the present invention, by this means, a process may be effectively performed to restore the state of the interconnection parts.

In accordance with embodiments of the present invention, in a disk drive that micro-drives a head-slider using the expansion and contraction of a piezoelectric element disposed on the suspension, deterioration in the accuracy with which positioning of the head is controlled due to deterioration in the interconnecting parts of conductive adhesive between the piezoelectric element and the drive line may be prevented. In accordance with embodiments of the present invention, as subsequently described, an example of a disk drive includes a HDD.

In accordance with embodiments of the present invention, the HDD includes with a dual-stage actuator having a positioning mechanism operated by a voice coil motor (VCM) and a positioning mechanism operated by a piezoelectric element on the suspension, which is referred to by the term of art, “micro-actuator.” With the micro-actuator, at least two connecting parts of the piezoelectric element are connected electrically to the drive line by conductive adhesive. One is a transmission line that transmits a variable drive signal to the drive line, the other is connected to wiring or a body that applies a standard potential. For example, with a structure in which one of the connecting parts of the piezoelectric element is connected to a suspension body at ground potential, which is a standard potential, the other connector is connected to a drive line that transmits a varying drive signal.

In accordance with embodiments of the present invention, the conducting adhesive includes a hardened resin and metal particles within the hardened resin. The piezoelectric element is physically connected to the drive line with the help of the hardened resin, and is connected electrically by the conductive particles within the hardened resin.

In accordance with embodiments of the present invention, the HDD applies a voltage having a prescribed maximum absolute value to the piezoelectric element. This voltage is applied to the connecting terminals at both ends of the piezoelectric element. The prescribed voltage is maintained by the good state of conductivity in the interconnecting parts between the piezoelectric element and the drive line, or alternatively, through restoration of this good connection. Where the interconnecting parts of conductive adhesive are left for an extended period of time without a voltage being applied, the conductivity of these parts becomes unstable. Specifically, the resistance of these interconnecting parts increases. In accordance with embodiments of the present invention, high resistance caused by deterioration may be eliminated or prevented by applying a designated voltage to these interconnecting parts of conductive adhesive.

In accordance with embodiments of the present invention, the HDD applies the above prescribed voltage to the interconnecting parts of conductive adhesive of the piezoelectric element each time a designated process is executed. The voltage that restores the state of electrical conduction in the interconnecting parts of conductive adhesive, which is sufficient to eliminate high resistance, is different from a voltage associated with burn out of electrically shorted parts within the piezoelectric element, and does not in practice apply stress to the piezoelectric element. For this reason, the HDD is able to apply the prescribed voltage to the interconnecting parts each time that a designated process is executed without causing deterioration to the piezoelectric element itself.

In accordance with embodiments of the present invention, this process restores the interconnecting parts to a good state of conduction before user data is read, or written, even where a high resistance has occurred due to deterioration in the interconnecting parts when an extended time has elapsed since the power was turned off. Thus, in accordance with embodiments of the present invention, in this way, the HDD may completely prevent the value of the resistance of the interconnecting parts from negatively affecting the positioning of the head-slider, when reading, or writing, user data.

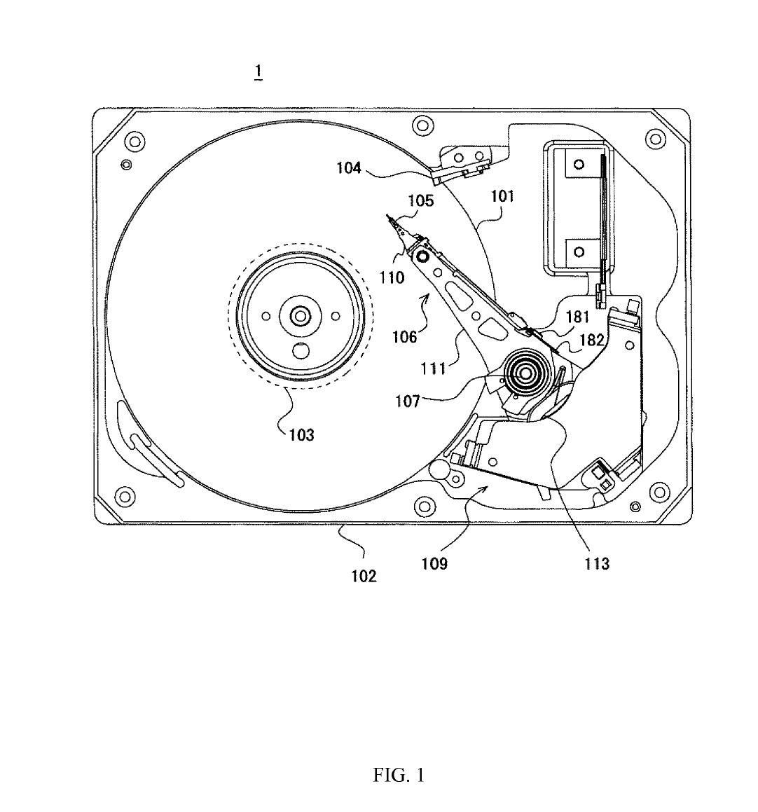

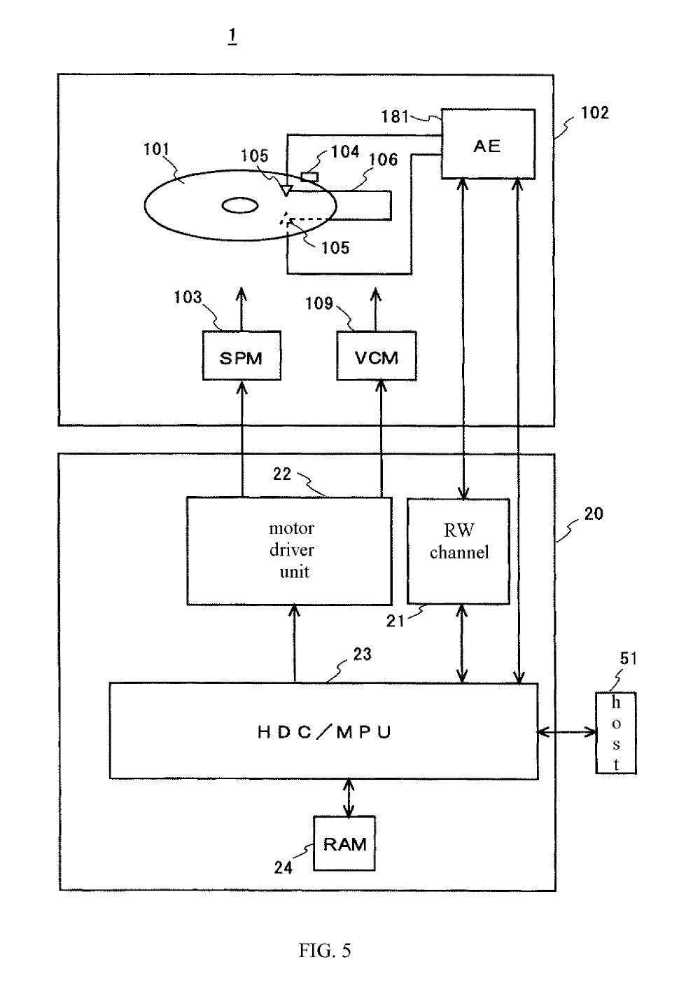

With reference now to FIG. 1, in accordance with embodiments of the present invention, a plan view of the chassis of HDD 1 without a cover is shown that illustrates the overall structure of HDD 1. The main parts of the mechanical structure of HDD 1 are housed within base 102. Control of the main constituent parts within base 102 is performed by a control circuit (see FIG. 5) on a printed-circuit board (PCB) affixed outside the base 102. HDD 1 has magnetic-recording disk 101 that is a disk that stores data, and head-slider 105 that accesses the magnetic-recording disk 101. As used herein, “access” is a term of art that refers to operations in seeking a data track of a magnetic-recording disk and positioning a magnetic-recording head on the data track for both reading data from, and writing data to, a magnetic-recording disk. Head slider 105 includes a magnetic-recording head that writes data to, or reads back user data from, magnetic-recording disk 101 and a slider on whose surface is formed this magnetic-recording head.

Actuator 106 supports head-slider 105, rotating to and fro about pivot axis 107 to drive head-slider 105 over rotating magnetic-recording disk 101. Voice coil motor (VCM) 109, which is the drive mechanism, drives actuator 106. Actuator 106 includes suspension 110, arm 111 and various structural members linked to voice coil 113 from the longitudinal tip of actuator 106 towards the direction in which head-slider 105 is disposed.

Spindle motor (SPM) 103 affixed to base 102 rotates magnetic-recording disk 101 at a designated angular speed. The pressure caused by the viscosity of the air between rotating magnetic-recording disk 101 and the air-bearing surface (ABS) of the slider facing magnetic-recording disk 101 is balanced by the load applied in the direction of magnetic-recording disk 101 by suspension 110, causing head-slider 105 to fly in proximity with a recording surface of the magnetic-recording disk 101. The signal from head-slider 105 is amplified by arm electronics (AE) module 181 in the vicinity of the pivot axis 107 of actuator 106. AE module 181 is mounted on substrate 182.

When head-slider 105 is not accessing the magnetic-recording disk 101, actuator 106 rests on ramp 104 outside magnetic-recording disk 101. The movement of actuator 106 from the magnetic-recording disk 101 to ramp 104 is referred to by the term of art, “unloading,” and the movement from ramp 104 to the magnetic-recording disk 101, by the term of art, “loading.” Embodiments of the present invention may be used both in an HDD with a ramp load/unload process, and also in HDDs not provided with ramp 104 in which actuator 106 moves to a region within the disk, or to a region outside the disk where access does not take place. The movement of actuator 106 to these regions is also referred to as unloading; and, the movement from these regions to the data regions is also referred to as loading.

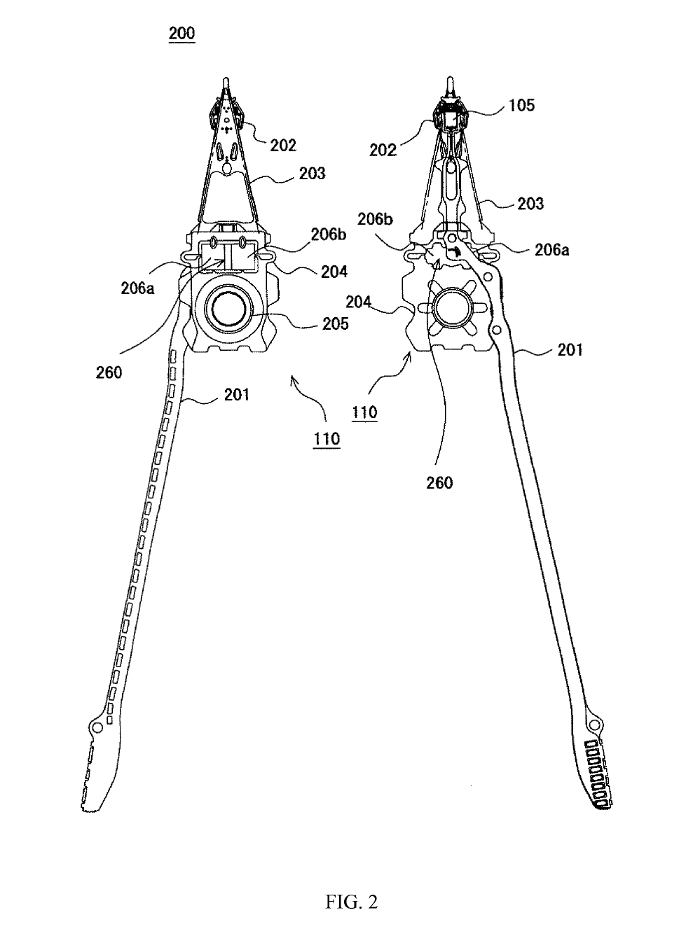

With reference now to FIG. 2, in accordance with embodiments of the present invention, a plan view schematically illustrating the structure of a head-gimbal assembly (HGA) 200 is shown. The diagram on the right shows the structure of HGA 200 on the side facing the disk, showing the opposite side on the left. HGA 200 includes suspension 110 and head-slider 105. Suspension 110 includes gimbal 202, load beam 203, stiffener 204, and mounting plate 205; these include the suspension body. In the structure shown in the diagram, the suspension body is equivalent to suspension 110. Transmission wiring 201 is formed on the suspension body.

With load beam 203 as a reference, and with gimbal 202 affixed on top of the load beam 203, transmission wiring 201 is further formed on gimbal 202, including the tail portion extending to the rear. Transmission wiring 201 has a flexible-printed-circuit (FPC) structure. Head slider 105 is affixed to the same surface as transmission wiring 201 on gimbal 202. HGA 200 has piezoelectric element 206 including part of a micro-actuator. Piezoelectric element 206 has two portions 266a and 266b. Portions 266a and 266b are polarized in opposite directions. In other words, their axes of polarization are parallel; but, the direction of polarization is opposite.

A single drive signal line is connected to piezoelectric element 206 on transmission wiring 201. This same drive signal is supplied to portions 266a and 266b, and portions 266a and 266b extend and contract in opposite directions in accordance with the same drive signal. Piezoelectric element portions 266a and 266b are affixed to stiffener 204.

In the above structure, one piece of piezoelectric element 206 has two portions 266a and 266b, but these two portions may be formed of separate pieces of piezoelectric element. Embodiments of the present invention are not limited to the suspension structure described above. For example, embodiments of the present invention may be applied to an HDD mounted with a suspension that does not have stiffener 204 and/or mount plate 205.

The terminals at the tip of transmission wiring 201 with a plurality of lead wires are connected to head-slider 105, gathered in a multi-connector in a terminal at the rear end, and connected to substrate 182 affixed to actuator 106. As shown in FIG. 1, AE module 181, which is the drive circuit for the head-slider, or more precisely, the read element and write element of the head-slider, is mounted on substrate 182. Moreover, wiring that transmits the drive signal from the motor driver unit (see FIG. 5) is formed on the substrate in addition to wiring that connects AE module 181 and other circuit elements. In this structure, the motor driver unit drives piezoelectric element 206.

Transmission wiring 201 transmits a signal that controls the drive of piezoelectric element 206. In one embodiment of the present invention, the direction connecting the tip of actuator 106, which includes suspension 110, and pivot axis 107 runs longitudinally, and the direction parallel to the main surface, which is the recording surface, of magnetic-recording disk 101 and perpendicular to the longitudinal direction, which is the direction of rotation of actuator 106, runs horizontally.

Load beam 203 functions as a precision laminate spring; and, in one embodiment of the present invention, the load beam 203 includes stainless steel (SS). Load beam 203 places a load on head-slider 105 due to the elasticity of the load beam 203. In another embodiment of the present invention, the gimbal 202, stiffener 204 and mount plate 205 may also include stainless steel (SS). Stainless steel has a high Young's modulus compared to other materials, and does not rust as a passivation film is formed on the surface of stainless steel. Thus, in accordance with embodiments of the present invention, material for the suspension includes stainless steel.

Head slider 105 is affixed to gimbal 202. Gimbal 202 is typically connected to load beam 203 by a laser spot weld. The rigidity of the gimbal 202 is less than that of load beam 203. Gimbal 202 applies posture control to head-slider 105 by tilting freely as well as supporting head-slider 105.

Stiffener 204 is affixed to the rear end of load beam 203. Stiffener 204 is typically bonded to load beam 203 with a laser spot weld. Stiffener 204 deforms together with the movement of piezoelectric element 260, and micro-drives head-slider 105. The micro-actuator includes piezoelectric element 260 and parts that move head-slider 105 by deforming with the movement of piezoelectric element 260 in suspension 110. The action of the micro-actuator is subsequently described. Mount plate 205 is laser spot welded to stiffener 204. Stiffener 204 and mount plate 205 include perforations; and, in general, the stiffener 204 and mount plate 205 are affixed by a swage process to each arm 111.

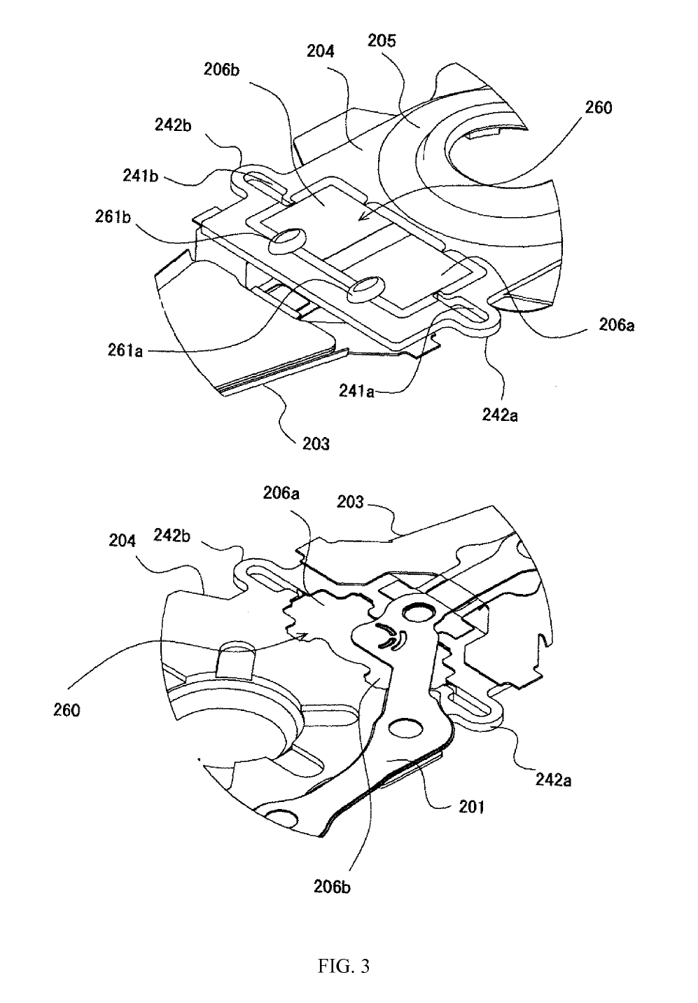

With reference now to FIG. 3, in accordance with embodiments of the present invention, a diagram illustrating a schematic oblique view of the structure of the piezoelectric element 260 and the vicinity of the piezoelectric element 260 in the HGA 200 is shown. The lower part of FIG. 3 shows the structure of the side facing magnetic-recording disk 101. The upper part of the diagram shows the structure on the other side. Portions 206a and 206b of piezoelectric element are aligned to left and right within the aperture formed in stiffener 204. Piezoelectric element 260 will typically be affixed with adhesive to stiffener 204 in the aperture. The aperture is a perforation, or alternatively, a concave portion, in the structure shown in FIG. 3, with piezoelectric element 260 affixed with adhesive to the bottom of an aperture, such that part of the bottom is perforated.

As described above, the front edge of stiffener 204 oscillates with extension in opposite directions of piezoelectric element portions 206a and 206b in a longitudinal direction. Together with the movement of stiffener 204, load beam 203 oscillates in the pitch direction. On the front side of load beam 203, head-slider 105 affixed on gimbal 202 is micro-driven in the radial direction of the disk together with the movement of load beam 203.

Stiffener 204 includes slits 241a and 241b on the respective outer edges, which are sides, of piezoelectric element portions 206a and 206b. Slits 241a and 241b are perforations. Moreover, stiffener 204 includes curved portions 242a and 242b that project to the outside in the horizontal direction. Arc-shaped curved portions 242a and 242b are formed on the respective outer edges, which are sides, of piezoelectric element portions 206a and 206b, demarcating part of slits 241a and 241b.

Curved portions 242a and 242b have elasticity. This elasticity deforms stiffener 204 due to the expansion and contraction in the lateral direction of piezoelectric element 260. Where the right-hand piezoelectric element portion expands and the left-hand piezoelectric element portion contracts, the front edge of the right-hand side of stiffener 204 moves forward, and the front edge on the left-hand side moves to the rear. Where the piezoelectric element portions to left and right move in the opposite direction, the front edges of stiffener 204 move in the opposite way.

As shown in FIG. 3, piezoelectric element portions 206a and 206b are connected respectively to the surface of stiffener 204 by interconnecting parts 261a and 261b on the reverse surface to that on which transmission wiring 201 is disposed. Interconnecting parts 261a and 261b are conductive adhesive, including hardened resin and metal particles included within the interconnecting parts 261a and 261b. Interconnecting parts 261a and 261b connect piezoelectric element portions 206a and 206b physically and electrically to the surface of stiffener 204.

In another embodiment of the present invention, the surface of stiffener 204 includes the same material as the material of the interior portion of the stiffener 204; but, when the interior portion includes stainless steel, the surface of the stiffener 204 may also include a stainless steel passivation film. Part or all of the surfaces of the other metal parts that include stiffener 204 and suspension 110 may be formed by metal plating, or alternatively, vacuum deposition, from another metal different from the metal of the interior portion. For example, in another embodiment of the present invention, part or all of the surfaces of the other metal parts that include stiffener 204 and suspension 110 may include gold, platinum, or alternatively, a layer of metal plate on which an oxide film on the surface of the layer is difficult to form.

Stiffener 204 is at ground potential in the circuitry that includes piezoelectric element 260. Piezoelectric element portions 206a and 206b are earthed via interconnecting parts 261a and 261b. Depending on the design, suspension 110, and similarly stiffener 204, may be given a potential different from that of ground potential. The conductive particles within the hardened resin of interconnecting parts 261a and 261b are connected electrically to the terminals of piezoelectric element portions 206a and 206b and stiffener 204. The hardened resin of interconnecting parts 261a and 261b help physically connect piezoelectric element 260 and stiffener 204.

Conductive paste, or alternatively, anisotropic conductive film (ACF), is known to the art as conductive adhesive. These resin materials are hardened using light or heat. In another embodiment of the present invention, from the point of view of ease of manufacture, a conductive paste may be used in this structure. Moreover, in another embodiment of the present invention, from the point of view of conductivity, a conductive adhesive that includes silver particles may be used.

As shown in the bottom diagram in FIG. 3, the terminals of piezoelectric element 260 and transmission wiring 201 are connected on a surface on the other side to interconnecting parts 261a and 261b. Transmission wiring 201 applies a drive voltage to piezoelectric element 260 that drives piezoelectric element 260, which controls the movement of piezoelectric element 260. In one embodiment of the present invention, the terminals of piezoelectric element 260 and transmission wiring 201 are connected using conductive adhesive in the same way as for stiffener 204. In another embodiment of the present invention, the conductive adhesive includes a conductive paste including silver particles.

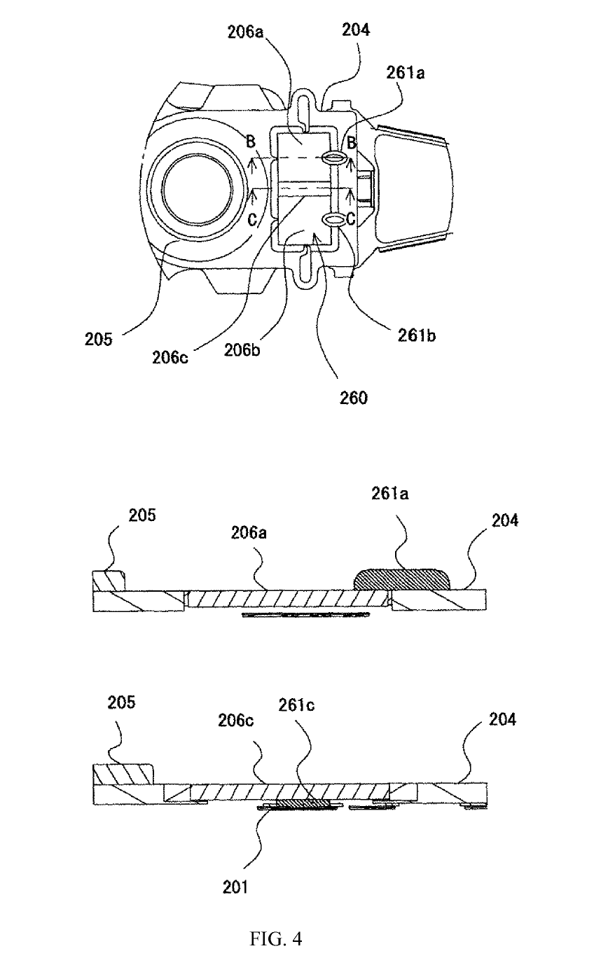

With reference now to FIG. 4, in accordance with embodiments of the present invention, the following are shown: a plan-view diagram illustrating interconnecting parts 261a and 261b and the surrounding structure of interconnecting parts 261a and 261b; a cross-section view illustrating the cross-sectional structure of interconnecting part 261a and the vicinity of interconnecting part 261a, illustrated by a cross-section through the line B-B; and, a cross-sectional view illustrating the cross-sectional structure of connecting part 261c and the vicinity of connecting part 261c, illustrated by cross-section through the line C-C. As shown in the cross-section in the center part of FIG. 4, connecting part 261a is in contact directly with the surface of stiffener 204 and the ground terminal of piezoelectric element 206a.

As shown in the lower diagram, connecting part 261c is connected to connecting terminal 206c of piezoelectric element 260 and the transmission wires on transmission wiring 201. Connecting part 261c includes the same structure as interconnecting parts 261a and 261b. In other words, connecting part 261c includes hardened resin and conductive particles. As well as electrically connecting piezoelectric element 260 and the transmission line, connecting part 261c helps connect the connecting piezoelectric element 260 and the transmission line, physically.

Interconnecting parts 261a-261c deteriorate with the elapsing of a long time over which voltage is not applied, and their resistance rises. In particular interconnecting parts 261a and 261b in contact with stiffener 204 have a strong tendency to deteriorate. This increase in the resistance of interconnecting parts including conductive adhesive is not limited to stiffener 204, but also occurs in connections to other parts including the suspension body. For example, with piezoelectric element placed on gimbal 202, load beam 203 or mount plate 205, the phenomenon of increased resistance occurs in these connections where these surfaces and the terminals of the piezoelectric element are connected by conductive adhesive.

Moreover, where interconnecting parts are in contact with a surface in which conductivity is potentially liable to obstruction through the forming of an oxide film, or similar film such as the passivation film in stainless steel, an increase in resistance due to deterioration in the interconnecting parts is liable to occur. Embodiments of the present invention can be applied with the piezoelectric element affixed to any position on the suspension, and, moreover, connected with conductive adhesive to any position on the transmission line, or suspension body. Of these, embodiments of the present invention may be useful where interconnecting parts affixed with conducting adhesive are in contact with the suspension body, and, moreover, may be particularly useful where the surface of the suspension body in contact with the interconnecting parts is a surface liable to have its potential conductivity obstructed by the formation of an oxide film.

As described above, increased resistance in the interconnecting parts is particularly likely to occur when in contact with the stainless steel surface of the suspension body. For this reason, embodiments of the present invention may be particularly useful for HDDs having a structure in which the piezoelectric element is interconnected with conductive adhesive to a suspension of stainless steel to whose surface another metal layer has not been attached. Moreover, amongst the variety of conductive adhesives, the phenomenon of increased resistance due to deterioration is particularly noticeable with conductive pastes including silver particles. Thus, embodiments of the present invention may be particularly useful in a HDD including interconnecting parts obtained by hardening a conductive paste that includes silver particles.

In one embodiment of the present invention, HDD 1 applies a prescribed voltage to piezoelectric element portions 206a and 206b each time a designated process is executed. By this means, in accordance with an embodiment of the present invention, an increase in resistance in parts 261a and 261b interconnecting the surface of stiffener 204 and piezoelectric element portions 206a and 206b may be prevented, and, also, in part 261c interconnecting transmission wiring 201 and piezoelectric element portions 206a and 206b, to restore the good state of resistance in interconnecting parts 261a-261c, whose resistance has risen prior to reading or writing user data. The process of supplying voltage to these interconnecting parts 261a-261c, associated with piezoelectric element 206, is performed by the controller in HDD 1 using the motor driver unit, as is next described

With reference now to FIG. 5, in accordance with embodiments of the present invention, a block diagram schematically illustrating the overall structure of the control system in HDD 1 is shown. Circuit elements are mounted on PCB 20 on the outside of base 102 that includes part of the disk enclosure (DE). Motor driver unit 22 drives SPM 103, VCM 109 and piezoelectric element 206 in accordance with control data from hard-disk controller/microprocessor unit (HDC/MPU) 23. Random-access memory (RAM) 24 functions as a buffer that temporarily stores read data and write data. AE module 181 selects head-slider 12 that will access magnetic-recording disk 101 from the plurality of head-sliders 105, and amplifies the read-back signal and sends the read-back signal to read/write channel (RW channel) 21. The recording signal from RW channel 21 is also sent to selected head-slider 105.

RW channel 21 amplifies the read-back signal supplied from AE module 13 to a fixed amplitude in the reading process, extracts the user data and servo data from the read-back signal obtained, and performs a decoding process. The decoded user read data and servo data are sent to HDC/MPU 23. Moreover, RW channel 21 encodes the write data supplied from HDC/MPU 23 in a writing process, and furthermore supplies a write signal to AE module 13 after conversion of the encoded write data to a write signal.

HDC/MPU 23, which is an example of the controller, executes overall control of HDD 1 and the processes for data processing; HDC/MPU 23 provides the following functions: read/write processing control; command execution sequence management; positioning control for head-slider 12 using the servo signal, referred to by the term of art “servo control;” interface control with host 51; defect management; and error response processing if an error occurs. In particular, in accordance with embodiments of the present invention, HDC/MPU 23 performs a restoration process to restore the condition of interconnecting parts 261a-261c of piezoelectric element 206.

HDC/MPU 23 performs the restoration process each time a designated process is executed. In one embodiment of the present invention, the designated process is selected from said group of processes consisting of: the initial setup processing; a loading process that moves actuator 106 over magnetic-recording disk 101 from the waiting position; an unloading process that moves actuator 106 from over magnetic-recording disk 101 to the waiting position; an error restoration process executed if an error occurs; and, an idling process that interrupts the access of head-slider 105 to magnetic-recording disk 101.

In one embodiment of the present invention, HDC/MPU 23 executes the restoration process each time the initial setup process takes place. When the power is off, there is a high likelihood of resistance increasing in interconnecting parts 261a-261c as no voltage is applied to interconnecting parts 261a-261c; and, moreover, the process of restoration in the initial setup process can take place without any effect on the performance of the HDD. In the following, a practical example of the restoration process in the initial setup process is described.

HDC/MPU 23 starts an initial setup process when power is turned on in HDD 1. In the initial start-up process HDC/MPU 23 performs such processes as: calibration of servo control in the head positioning; setting the parameters in RW channel 21; measuring the clearance; and, checking the read/write data. The initial setup process is executed prior to read/write processing in accordance with commands from host 51.

HDC/MPU 23 performs a process that always applies a prescribed voltage to piezoelectric element 260 and interconnecting parts 261a-261c across transmission wiring 201 and suspension 110 in the initial setup process. Motor driver unit 22 applies the prescribed voltage to piezoelectric element 260 and interconnecting parts 261a-261c. Motor driver unit 22 applies the prescribed voltage simultaneously to both portions of piezoelectric element 206a and 206b. By this means it is possible to effectively perform a restoration process for interconnecting parts 261a-261c. Moreover, motor driver unit 22 applies the prescribed voltage simultaneously to all the piezoelectric elements on the suspension mounted in HDD 1. Thus, in accordance with embodiments of the present invention, by this means, a restoration process for all interconnecting parts 261a-261c is effectively performed.

In one embodiment of the present invention, the voltage applied in the restoration process for interconnecting parts 261a-261c is a DC voltage. A large number of conductive particles are present within the conducting adhesive. If a DC current is made to flow within the conducting adhesive, an attractive force acts between the current flowing in parallel. The attractive force acts on the conductive particles in which the current is flowing; and, conductivity stabilizes with the concentration of the conductive path. Conversely, if an alternating current is used, an attractive force also acts; but, as the attractive force is intermittent, the effect of concentrating the conductive particles in one place is lost. For this reason, bonding between the metal of conductive particles is easier to encourage with a direct current applied, rather than an alternating current.

HDC/MPU 23 applies the prescribed voltage for a pre-set time to piezoelectric element 260 and interconnecting parts 261a-261c via motor driver unit 22. For example, motor driver unit 22 applies a direct current voltage of the described value to piezoelectric element 260 and interconnecting parts 261a-261c for from a few milliseconds (ms) to several seconds (s). In one embodiment of the present invention, from the point of view of simplicity of control, the prescribed time is fixed; but, alternatively, the prescribed time may be varied under certain conditions. HDC/MPU 23 sets the control data indicating the voltage value applied to piezoelectric element 260 in the register of motor driver unit 22. Motor driver unit 22 applies the DC voltage that is set in the register to piezoelectric element 260 and interconnecting parts 261a-261c during the period indicated by HDC/MPU 23 across wiring 201 and suspension 110.

HDC/MPU 23 is able to control the voltage supplied by motor driver unit 22 to piezoelectric element 260, and connection parts 261a-261c, by supplying data showing the voltage value and support for the supply of voltage separately to motor driver unit 22, or alternatively, by setting data indicating the value of the voltage using the clock. By varying the voltage value set in the register of motor driver unit 22, an AC voltage can be applied.

Motor driver unit 22 drives piezoelectric element 260 even in the positioning of head-slider 105 when reading or writing of user data. In one embodiment of the present invention, the maximum absolute value for the voltage applied in the restoration process for interconnecting parts 261a-261c is within the range of voltages that can be applied in the control of piezoelectric element 260 by motor driver unit 22. There is no deterioration of piezoelectric element 260 itself in the range of voltages used in normal drive control of piezoelectric element 260, in other words, when accessing magnetic-recording disk 101 with head-slider 105, as in a read, or write, operation.

In yet another embodiment of the present invention, HDC/MPU 23 instructs motor driver unit 22 with the maximum value in the range of voltages that can be applied by motor driver unit 22 in controlling piezoelectric element 260. For example, where one end of piezoelectric element 260 is earthed via suspension 110, motor driver unit 22 will typically apply to piezoelectric element 260 a negative voltage centered on the bias voltage, causing piezoelectric element 260 to contract. For example, where the bias voltage is 10 volts (V), the maximum amplitude is 16 V, and the maximum voltage is 18 V. Thus, in one embodiment of the present invention, the maximum absolute voltage value that motor driver unit 22 can apply in the process of restoring the resistance of interconnecting parts 261a-261c is less than 18 V, or alternatively, just 18 V.

As described above, in the range of voltages used in the normal drive control of piezoelectric element 260, there is no deterioration of piezoelectric element 260 itself. On the other hand, the voltage for restoring the resistance of interconnecting parts 261a-261c to a good state will vary with the interconnecting parts. For this reason, by applying the maximum voltage, a good resistance state may be restored to interconnecting parts 261a-261c more reliably. As a restoration process for interconnecting parts 261a-261c may be performed using the same drive circuit as normal control, motor driver unit 22 may include a simple circuit structure.

In another embodiment of the present invention, HDC/MPU 23 applies the prescribed voltage to piezoelectric element 260 and interconnecting parts 261a-261c before the loading of actuator 106 begins. By this means, HDC/MPU 23 is able to perform accurate servo control during the servo control immediately subsequent to the first loading after start-up; and, HDD 1 reliability is improved. In an HDD 1 with a ramp loading/unloading system, the voltage is applied when actuator 106 is on ramp 104. In a continuous start and stop (CSS) type HDD 1, the voltage is applied when head-slider 105 is in contact with the waiting region, or alternatively, is flying above the waiting region.

In another embodiment of the present invention, HDC/MPU 23 performs the restoration process for interconnecting parts 261a and 261b of the piezoelectric element even during the time from the initial setup process after start-up until power is switched off. As described above, in one embodiment of the present invention, HDC/MPU 23 applies the prescribed voltage to interconnecting parts 261a-261c during one or a plurality, which may include all, of the loading processes, unloading processes, error restoration, and idling processes. In another embodiment of the present invention, this state restoration process is performed during loading and unloading processes where head-slider 105 is outside the data region and actuator 106 is resting on ramp 104; in other words, this state restoration process is performed either before movement of the actuator 106 in the loading process, or alternatively, after movement of the actuator 106 during the unloading process. Thus, in accordance with embodiments of the present invention, by this means, any effect of the servo control of actuator 106 on the restoration process may be avoided.

When there are errors during the seeking process, loading process or read/write process, HDC/MPU 23 starts an error restoration process corresponding to the error that has occurred. HDD 1 has an error restoration process table that corresponds to processes in which errors have occurred. This table stores a plurality of operations that should be executed in the error restoration process. HDC/MPU 23 refers to this table and executes the operations sequentially with priority given to the highest operation. When an error has been rectified by any of the operations, HDC/MPU 23 returns to the normal process. In any of the operations, HDC/MPU 23 applies the prescribed voltage to piezoelectric elements 206a and 206b, and similarly to interconnecting parts 261a and 261b.

The seeking process is a process in which head-slider 105 moves from current position of the head-slider 105 to a target position. When the head-slider 105 has stabilized its position in the target position, which occurs when the position error signal (PES) is within a standard range, HDC/MPU 23 completes the seeking process, and moves to the track-following process. Moreover the load process is a process that moves actuator 106, and the associated head-slider 105, from the waiting position to a position in which the servo data on magnetic-recording disk 101 can be read. The waiting position is the position on the ramp in HDD 1 with ramp 104, or alternatively, a position within the waiting area in a CSS-type HDD 1.

For example, for an error that occurs in the seeking process, or the loading process, HDC/MPU 23 moves actuator 106 to the inside circumference of the magnetic-recording disk 101, and presses the actuator 106 against the inner crash stop. Errors occur in the seeking process, or the loading process, due to the fact that accurate servo control may not be possible, so pressing against the crash stop reduces the possibility of a head crash.

In general HDD 1 includes two crash stops adjacent to the inner and outer circumferences of the magnetic-recording disk 101. These respectively demark the range over which actuator 106 moves. The innermost position is when actuator 106 comes into contact with the inner circumference crash stop; and, the outermost position is when actuator 106 comes into contact with the outer circumference crash stop. With HDD 1 provided with ramp 104, actuator 106 is on ramp 104 in the outermost position, and is on magnetic-recording disk 101 in the innermost position. In CSS, neither position actuator 106 is on the magnetic-recording disk 101.

The reason why HDC/MPU 23 is unable to perform accurate servo control can be due to increased resistance in parts 261a-261c interconnecting with the piezoelectric element. When actuator 106 is pressed against the innermost crash stop, HDC/MPU 23 performs the restoration process for interconnecting parts 261a-261c. Thus, in accordance with embodiments of the present invention, by this means, the possibility of being able to restore a seek error, or alternatively, a loading error, is increased.

If a command does not arrive in the prescribed time from host 51, HDC/MPU 23 starts an idling process. In the idling process, HDC/MPU 23 moves actuator 106 to the waiting position. HDC/MPU 23 thereafter performs the restoration process, coincident with the idling process. HDC/MPU 23 stops SPM 103 to reduce power consumption during the idling process, or stops part of the action of the control circuit.

With the above structure, motor driver unit 22 moves all the micro-actuators on the suspension, simultaneously. In other words, even micro-actuators for head-sliders 105 that are not accessing magnetic-recording disk 11 are driven together with micro-actuators for head-slider 105 that are accessing the disk. A single drive signal is sent from motor driver unit 22 to all of the micro-actuators. In another embodiment of the present invention, given this drive control for the micro-actuators, the control of the motion of actuator 106 may be driven by another micro-actuator.

In another embodiment of the present invention, the direction of movement of micro-actuator HGA 200 affixed to one surface of one arm 111 is opposite to micro-actuator HGA 200 affixed to the other surface. For example, when head-slider 105 is rotating on the inner circumference of the magnetic-recording disk 101 with one of the micro-actuators on arm 111, head-slider 105 on another micro-actuator is rotating on the outside circumference of the magnetic-recording disk 101. In other words, expansion and contraction of the piezo portion on the innermost side is opposite for HGA 200 on the same arm 111, and expansion and contraction of the piezo portion on the outermost side is also opposite.

Given this situation, the drive of the micro-actuator of HGA 200, which includes piezoelectric element 260, may be controlled independently. For example, only the micro-actuator, which includes piezoelectric element 260, that micro-drives head-slider 105 selected by AE module 181 is controlled; and, no drive signal is sent to the other micro-activator, which includes another piezoelectric element similar to piezoelectric element 260, at this time. In this way, as only the piezoelectric element 260 that corresponds to the accessing head-slider 105, which is reading or writing data, is driven, the oscillation occurring in actuator 106 can be suppressed compared to when the another piezoelectric element similar to piezoelectric element 260 is driven, simultaneously. Moreover, with the drive time for piezoelectric element 260 shorter than the drive time for controlling drives simultaneously, the life of piezoelectric element 260 may be extended.

A description of certain embodiments of the present invention has been given above; but, the invention is not limited to such embodiments. Changes, additions and adaptations to the elements of the above described embodiments of the present invention can be made within the spirit and scope of embodiments of the present invention. For example, embodiments of the present invention are particularly useful in a HDD; but, embodiments of the present invention may also be applied to other disk drives. Embodiments of the present invention can also be applied to a disk drive having a head-slider with only a read element. The range of application of embodiments of the present invention is not limited to the number of piezoelectric elements mounted on the suspension. For embodiments of the present invention, the absolute value of the voltage applied to the piezoelectric element is above the prescribed value, and a plus or a minus voltage can be applied.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A disk drive configured with micro-actuator interconnect conditioning, said disk drive comprising:
a disk;
a head, said head configured to access said disk;
an actuator, said actuator comprising:
a suspension that supports said head; and
an arm that supports said suspension;
a piezoelectric element, said piezoelectric element disposed on said suspension, and electrically connected to a first drive line and a second drive line, said piezoelectric element configured to change said position of said head by expanding and contracting;
a hardened conductive adhesive, said hardened conductive adhesive electrically connected to at least one connecting part of said piezoelectric element and said first drive line;
a voltage-supply circuit, said voltage-supply circuit configured to supply a voltage to said piezoelectric element; and
a controller, said controller configured to control a voltage-control circuit each time a designated process is executed, and to apply a voltage to said piezoelectric element across said first drive line and said second drive line with a prescribed maximum absolute value.

2. The disk drive of claim 1, wherein said conductive adhesive comprises an interconnecting part between a surface of a body of said suspension and said connecting part; said suspension comprises said first drive line; and said controller is configured to apply a standard voltage to a connecting terminal.

3. The disk drive of claim 2, wherein said surface of said body comprises an oxidized metal film.

4. The disk drive of claim 3, wherein said suspension comprises a stainless steel structure; and said oxidized metal film comprises a passivation film.

5. The disk drive of claim 1, wherein said designated process is selected from said group of processes consisting of an initial setup process for said disk drive, a loading process that moves said suspension over said disk from a waiting position, an unloading process that moves said suspension from over said disk to said waiting position, an error recovery process, and an idling process that interrupts access of said head to said disk.

6. The disk drive of claim 5 wherein in said initial setup process, said controller is configured to apply a voltage to said piezoelectric element with said prescribed maximum absolute value before moving said head over said disk from said waiting position.

7. The disk drive of claim 1, wherein said controller is configured to apply a DC voltage having said prescribed maximum absolute value to said piezoelectric element.

8. The disk drive of claim 1, wherein said voltage-supply circuit comprises a driver circuit that is configured to drive said piezoelectric element during access by said head; and, said maximum absolute value comprises a value within a range of voltages that can be applied to said piezoelectric element by said driver circuit during access of said head to said disk.

9. The disk drive of claim 8, wherein said maximum absolute value matches a maximum absolute value of voltages that can be applied to said piezoelectric element by said driver circuit during access to said disk by said head.

10. The disk drive of claim 1, wherein said piezoelectric element comprises two portions having different directions of polarization; and, said controller is configured to simultaneously apply voltage with said prescribed maximum absolute value to said two portions.
